(19) United States
(12) Patent Application Publication
(10) Pub. No.: US 2017/0345006 A1
(43) Pub. Date: Nov. 30, 2017

(54) SYSTEMS AND METHODS FOR LOCATION DATA VERIFICATION

(71) Applicant: MasterCard International Incorporated, Purchase, NY (US)

(72) Inventor: Manoneet Kohli, O'Fallon, MO (US)

(21) Appl. No.: 15/167,449

(22) Filed: May 27, 2016

(51) Int. Cl. G06Q 20/40; H04L 29/08; G06Q 50/00

(52) U.S. Cl. CPC G06Q 20/4093; H04L 67/18; G06Q 20/4016; G06Q 50/01

(57) ABSTRACT

A method of verifying a location of an accountholder is provided. The method is implemented using a location verification (LV) computing device. The method includes receiving a first data message including first transaction data associated with a travel-related card-not-present transaction of the accountholder to a target location, analyzing the first transaction data to extract a first location identifier associated with the target location, receiving a second data message including second transaction data for a target location transaction performed by the accountholder at a merchant computing device associated with the target location, analyzing the second transaction data to extract a merchant location identifier corresponding to the merchant computing device for the target location transaction, verifying that the accountholder is performing the target location transaction at the target location by determining that the first location identifier matches the merchant location identifier, and authorizing the target location transaction.

### BACKGROUND

This disclosure relates to location data verification systems. More specifically, the disclosure relates to verifying an accountholder's location information in order to authenticate and/or authorize the accountholder's electronic activity.

As a matter of background, accountholders (e.g., of a financial account) may use a variety of methods to perform payment transactions to purchase goods and services. These methods include use of plastic payment cards and personal computing devices (also known as accountholder computing devices). A payment processor computing device processes the payment transactions over a processing network. The payment cards and/or personal computing devices may be used at point of sale (POS) devices operated by merchants. Where accountholder computing devices are used, transaction data may be transmitted between the accountholder computing device and the payment processor computing device during a transaction. Transaction data may include location data, such as an IP address for the accountholder computing device, an accountholder address, a location identifier for a router or cell tower used by the accountholder computing device, or the like. Transaction data may also include transaction date/time, transaction amount, merchant identifiers, or the like. Also, these payment transaction methods may be used remotely from the merchant (e.g., at the accountholder's home or office). Occasionally, an accountholder will travel from the accountholder's domicile (i.e., place of regular residence, such as a resident city) to a target location (e.g., a different city or country) and perform a transaction with a merchant at the target location. Such a transaction may also be referred to herein as a target location transaction.

In the scenario where an accountholder uses a payment card for the target location transaction, known systems suffer from several limitations. For example, some known systems and methods are prone to declining the target location transaction, based on a determination that the target location transaction originated from a location other than the accountholder's domicile and therefore was likely attempted by a person with unauthorized access to the payment card information. Known systems are sometimes unable to recognize that the legitimate accountholder has traveled to the target location.

Some known systems track accountholder travel, such as through a travel membership program affiliated with a payment processing network. However, these systems are also limited to tracking travel that was recorded within the travel membership program, do not recognize unrecorded travel, and thus will decline a transaction from a target location that does not appear in membership program records. Moreover, known systems are also unable to use secondary indicators of an accountholder's travel to recognize travel activity and thus will flag transactions from the target location as fraudulent. Using such known systems, completing a transaction from a target location will often involve contacting the accountholder's issuing bank (e.g., via phone) to confirm the accountholder's travel activity. This may cause inconvenience to the accountholder. Communicating with an issuing bank may be difficult or impossible based on the accountholder's location (e.g., in a location with poor telephone coverage). Additionally, methods involving the accountholder contacting the issuing bank are susceptible to security problems such as man-in-the-middle attacks.

### BRIEF DESCRIPTION

In one aspect, a method of verifying a location of an accountholder is provided. The method is implemented using a location verification (LV) computing device. The method includes receiving, from an accountholder computing device, by the LV computing device, a first data message including first transaction data associated with a travel-related transaction of the accountholder to a target location, wherein the travel-related transaction is a card-not-present transaction. The method also includes analyzing the first transaction data to extract a first location identifier associated with the target location. The method further includes receiving, by the LV computing device, a second data message including second transaction data for a target location transaction performed by the accountholder at a merchant computing device, wherein the merchant computing device is associated with the target location. The method also includes analyzing the second transaction data to extract a merchant location identifier corresponding to the merchant computing device for the target location transaction. The method further includes verifying, by the LV computing device, that the accountholder is performing the target location transaction at the target location by determining that the first location identifier matches the merchant location identifier. The method also includes authorizing, by the LV computing device, the target location transaction based on the verification.

In another aspect, a system for verifying a location of an accountholder is provided, the system includes a memory device configured to store location data, and a location verification (LV) computing device in communication with a memory device. The LV computing device is configured to receive, from an accountholder computing device, a first data message including first transaction data associated with a travel-related transaction of the accountholder to a target location, wherein the travel-related transaction is a card-not-present transaction. The LV computing device is also configured to analyze the first transaction data to extract a first location identifier associated with the target location. The LV computing device is further configured to receive a second data message including second transaction data for a target location transaction performed by the accountholder at a merchant computing device, wherein the merchant computing device is associated with the target location. The LV computing device is also configured to analyze the second transaction data to extract a merchant location identifier corresponding to the merchant computing device for the target location transaction. The LV computing device is further configured to verify that the accountholder is performing the target location transaction at the target location by determining that the first location identifier matches the merchant location identifier. The LV computing device is also configured to authorize the target location transaction based on the verification.

In a further aspect, a non-transitory computer readable medium that includes computer executable instructions for verifying a location of an accountholder for a payment transaction conducted by the accountholder with a merchant is provided. When executed by a location verification (LV) computing device comprising a processor in communication with a memory device, the computer executable instructions cause the LV computing device to receive, from an accountholder computing device, a first data message including first transaction data associated with a travel-related transaction of the accountholder to a target location, wherein the travel-related transaction is a card-not-present transaction. The computer executable instructions also cause the LV computing device to analyze the first transaction data to extract a first location identifier associated with the target location. The computer executable instructions further cause the LV computing device to receive a second data message including second transaction data for a target location transaction performed by the accountholder at a merchant computing device, wherein the merchant computing device is associated with the target location. The computer executable instructions also cause the LV computing device to analyze the second transaction data to extract a merchant location identifier corresponding to the merchant computing device for the target location transaction. The computer executable instructions further cause the LV computing device to verify that the accountholder is performing the target location transaction at the target location by determining that the first location identifier matches the merchant location identifier. The computer executable instructions also cause the LV computing device to authorize the target location transaction based on the verification.

### BRIEF DESCRIPTION OF THE DRAWINGS

FIGS. 1-8 show example embodiments of the methods and systems described herein.

FIG. 1 is a schematic diagram illustrating an example accountholder location verification platform for authorizing payment card transactions based on a verified location.

FIG. 2 is a block diagram of an example accountholder location verification computing system, in which a variety of computing devices are communicatively coupled to each other via a plurality of network connections.

FIG. 3 illustrates an example configuration of a server system that includes the location verification computing device shown in FIG. 2.

FIG. 4 illustrates an example configuration of a user system, such as an accountholder computer device configured to transmit location data.

FIG. 5 shows an example configuration of a server system, such as an LV computing device configured for location verification for an accountholder.

FIG. 6 shows an example message flow illustrating how the LV computing device verifies the location of an accountholder during a transaction.

FIG. 7 shows an example method flow illustrating how the LV computing device verifies the location of an accountholder.

FIG. 8 shows an example configuration of a database within a computing device, along with other related computing components, that may be used to verifies the location of an accountholder.

Like numbers in the Figures indicate the same or functionally similar components.

### DETAILED DESCRIPTION

The present disclosure relates to a location verification (LV) computing device. The LV computing device is configured to verify an accountholder's location using data from one or more transactions made with the accountholder's payment card account. In at least some implementations, the LV computing device is in communication with the payment processor computing device. In other embodiments, the LV computing device is integrated into or part of the payment processor computing device.

In at least some implementations, the LV computing device receives a first set of transaction data (also referred to herein as first transaction data) as it is transmitted between the accountholder computing device and the payment processor computing device. In the example embodiment, the first transaction data potentially contains travel information. For example, the accountholder will purchase an airline ticket to travel to a target location. The airline ticket purchase may be made via an online platform provided by a payment processor or via an airline website or some other channel. In another embodiment, the accountholder may purchase a guided tour of the target location (e.g., a walking tour of historical sites in a city). In at least some implementations, the transaction for the airlines purchase or the guided tour is a card-not-present transaction. In other words, the accountholder does not present a physical payment card to a merchant when buying the airline ticket or the guided tour, but rather provides the account information via a website, a software application, an electronic wallet, a telephone call, or some other electronic means.

The LV computing device is configured to store the first transaction data in a memory device (e.g., an electronic database). The LV computing device associates the airline ticket purchase to the accountholder's account (e.g., by using an identifier or variable representing the association). The LV computing device is configured to analyze the first transaction data for the presence of a first location identifier. The first location identifier indicates a location associated with the travel information for the accountholder. In other words, the first location identifier is associated with the target location as explained above. In the case of an airline ticket, the first location identifier may be the destination city for the airline flight the accountholder is taking. In the case of the guided tour, the first location identifier may be the city or town the accountholder is touring. The LV computing device is configured to analyze the first transaction data and extract the first location identifier regardless of format or specific variable in which the first location identifier may be stored.

In at least some implementations, the LV computing device is configured to analyze every transaction for travel information. For example, the LV computing device may determine that a certain transaction involves location identifiers that are distinct from the accountholder's typical domicile location (e.g., the transaction involves different cities or countries). In at least some implementations, the LV computing device is configured to flag or mark such accounts that indicate travel information. For example, the LV computing device may copy records for such accounts into a separate transaction database for quick retrieval in the future.

When the accountholder travels to the target location, the accountholder may perform a target location transaction. This may be a card-present transaction (i.e., where a physical payment card is presented) or a card-not-present transaction. Target location transactions will generate a second set of transaction data (also referred to herein as second transaction data). This second transaction data includes location information for a merchant computing device used for the target location transaction. For example, the accountholder may use a physical payment card at an electronic point-of-sale (POS) device at the merchant location. In at least some implementations, the second transaction data for the target location transaction performed at the POS device will bear location information (e.g., a city name, an IP address for the POS device, or other electronically encoded location information), also referred to herein as a merchant location identifier or target location identifier.

The LV computing device is configured to receive the second transaction data and determine whether to authorize the target location transaction. In at least some implementations, the LV computing device recognizes that the second transaction data is for an account that was previously flagged or marked as having performed a travel-related transaction (based on, for example, the first transaction data). The LV computing device analyzes the second transaction data and extracts the merchant location identifier associated with the merchant computing device. The LV computing device is configured to compare the first location identifier (i.e., that which is extracted from the first transaction data for a transaction performed at the domicile location) and the merchant location identifier. If there is a match, the LV computing device determines that a) the accountholder traveled to the target location and b) it is the accountholder that is attempting the target location transaction, rather than an unauthorized person. In the case of such a match, the LV computing device is configured to authorize the transaction, or to communicate to another computing device (e.g., an issuer bank computing device) that the transaction is legitimate and thus should be authorized. In at least some implementations, the LV computing device updates the second transaction data with a verification identifier and sends the updated data to an issuer bank computing device.

In at least some implementations, the LV computing device is configured to verify an accountholder's travel to a target location in lieu of (or in addition to) a first transaction performed by the accountholder while at his domicile location. For example, the accountholder may have used cash to purchase the airline ticket, thus generating no first set of transaction data from which to extract the first location identifier. In such a case, the LV computing device is configured to analyze secondary travel indicators to determine whether the accountholder traveled to the target location. For example, the LV computing device uses the accountholder's public social media activity to detect indicators of the accountholder's travel to the target location. In at least some implementations, the LV computing device receives publicly available social media activity data for the accountholder, specifically social media location data. This social media location data may include, for example, social media check-in activity, social media generated geolocation data for the accountholder's computing device, social media content of the accountholder that is tagged with a specific location, or the like.

For example, the LV computing device may, in the absence of the first transaction data, receive only the second transaction data for a target location transaction. Initially, the LV computing device flags the second transaction data for further analysis. The LV computing device is configured to extract an accountholder identifier from the second transaction data (e.g., an accountholder name) in addition to the merchant location identifier. The LV computing device is configured to extract one or more social media location identifiers from the received social media location data to determine whether the accountholder is currently traveling. For example, the social media location identifiers may indicate locations in and around the accountholder's domicile, but may also indicate the target location. The LV computing device parses each received social media location identifier and compares it to the merchant location identifier to determine whether the accountholder is performing the target location transaction, rather than an unauthorized person.

The technical problems addressed by this system include at least one of: (i) inability of payment processing systems to timely receive location data that may authenticate a user during a transaction, (ii) inability of accountholder computing devices to transmit otherwise available location data in order to verify the location of an accountholder, and (iii) wasted computer processing and network traffic generated as a result of declines for transactions made by authorized accountholders.

The methods and systems described herein may be implemented using computer programming or engineering techniques including computer software, firmware, hardware, or any combination or subset thereof, wherein the technical effects may be achieved by i) receiving, from an accountholder computing device, by an LV computing device, a first data message including first transaction data associated with a travel-related transaction of the accountholder to a target location, wherein the travel-related transaction is a card-not-present transaction, ii) analyzing the first transaction data to extract a first location identifier associated with the target location iii) receiving, by the LV computing device, a second data message including second transaction data for a target location transaction performed by the accountholder at a merchant computing device, wherein the merchant computing device is associated with the target location iv) analyzing the second transaction data to extract a merchant location identifier corresponding to the merchant computing device for the target location transaction v) verifying, by the LV computing device, that the accountholder is performing the target location transaction at the target location by determining that the first location identifier matches the merchant location identifier, and vi) authorizing, by the LV computing device, the target location transaction based on the verification.

The resulting technical benefits achieved by this system include at least one of: (i) new and improved usage of existing location data received from accountholder and merchant computing devices, (ii) improved electronic transaction processing involving fewer declines, thereby leading to decreases in unnecessary network traffic and computer processing, (iii) generation of useful data for issuer computing devices and merchant computing devices, where issuers and merchants can better predict fraudulent activity by more accurately identifying non-fraudulent accountholder activity, and (iv) ability of issuers and merchants to authenticate authorized accountholders for potentially fraudulent transactions without the need for additional computer infrastructure.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable storage medium. In an example embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application in industrial, commercial, and academic applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

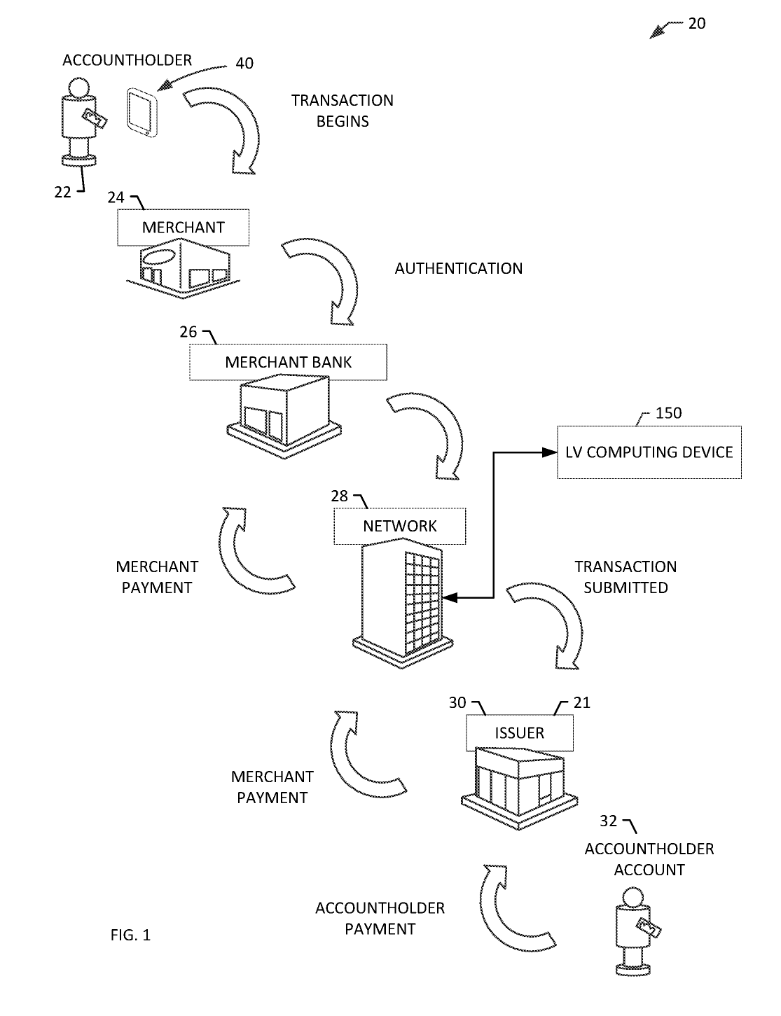

FIG. 1 is a schematic diagram illustrating an example accountholder location verification platform for authorizing payment card transactions based on a verified location. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, New York). Embodiments described herein also relate to a location verification (LV) computing device 150 that is communicatively coupled to an interchange network computing device 28. The LV computing device 150 is configured to receive transaction data from interchange network computing device 28 and verify a location of an accountholder that has initiated a transaction.

In the exemplary location verification platform, a financial institution called the “issuer” issues an account, such as a credit card account, to the accountholder or accountholder 22, who uses the account to tender payment for a purchase from a merchant 24. In one embodiment, the accountholder presents a physical payment card to merchant 24 (also known as a card-present transaction). In another embodiment, the accountholder does not present a physical payment card and instead performs a card-not-present transaction. For example, the card-not-present transaction may be initiated via an electronic wallet application, through a website or web portal, via telephone, or any other method that does not require the accountholder to present a physical payment card to merchant 24 (e.g., via swiping or tapping the card).

To accept payment with the transaction card, merchant 24 establishes an account with a financial institution that is part of the financial payment system. This financial institution is usually called the “merchant bank,” the “acquiring bank,” or the “acquirer.” In one embodiment, accountholder 22 tenders payment for a purchase using a transaction card at a transaction processing device 40 (e.g., a point of sale device), then merchant 24 requests authorization from a merchant bank 26 for the amount of the purchase. The request is usually performed through the use of a point-of-sale terminal, which reads accountholder 22's account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether accountholder 22's account 32 is in good standing and whether the purchase is covered by accountholder 22's available credit line. Based on these determinations, the request for authorization will be declined or accepted. If the request is accepted, an authorization code is issued to merchant 24.

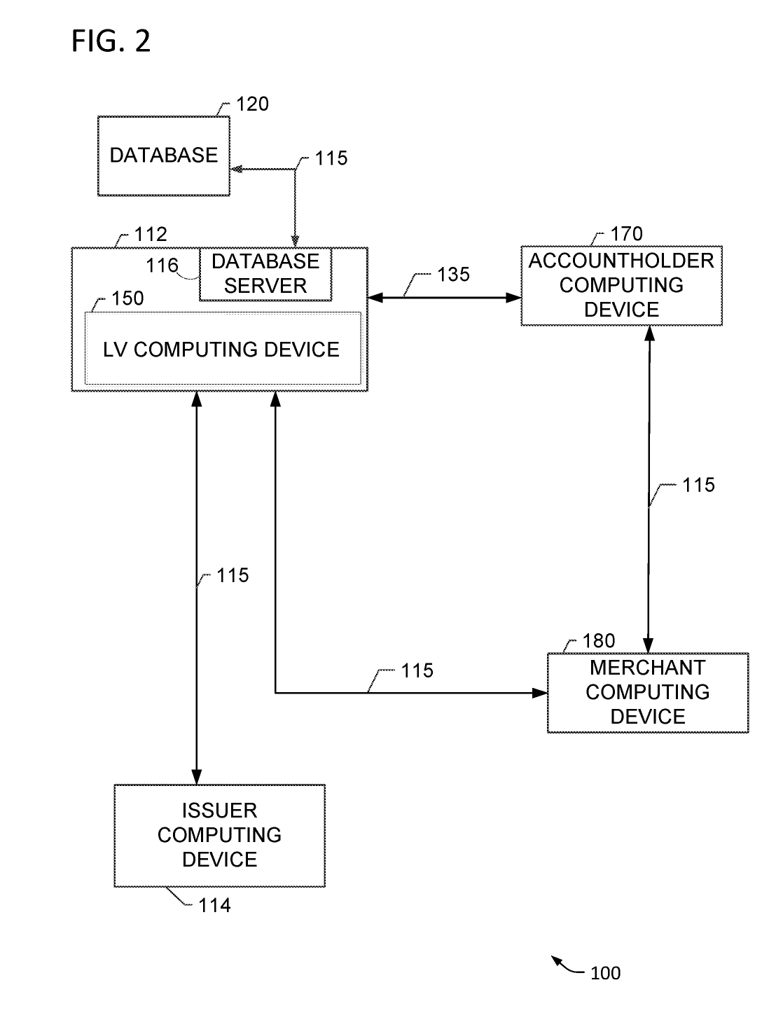

When a request for authorization is accepted, the available credit line of accountholder 22's account 32 is decreased. Normally, a charge for a payment card transaction is not posted immediately to accountholder 22's account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If accountholder 22 cancels a transaction before it is captured, a “void” is generated. If accountholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, accountholder account information, a type of transaction, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant 24's account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described above, the various parties to the payment card transaction include one or more of the parties shown in FIG. 1 such as, for example, accountholder 22, merchant 24, merchant bank 26, interchange network 28 (also referred to herein as payment processor 28), issuer bank 30, and/or an issuer processor 21.

FIG. 2 is a block diagram of an example location verification computing system, in which a variety of computing devices are communicatively coupled to each other via a plurality of network connections. These network connections may be Internet, LAN/WAN, or other connections capable of transmitting data across computing devices. Environment 100 shows location verification (LV) computing device 150 and a database server 116. In one embodiment, LV computing device 150 and database server 116 are components of a location verification (LV) system 112. Server system 112 may be a server, a network of multiple computer devices, a virtual computing device, or the like. LV computing device 150 is connected to at least one accountholder computing device 170, a merchant computing device 180, and an issuer computing device 114 via at least a network connection 115 and network connection 115.

In one embodiment, LV computing device 150 is configured to receive transaction data from merchant computing device 180, over a network connection 115. As noted with respect to FIG. 1, when an accountholder performs a transaction at a merchant location, transaction data is generated. Transaction data may be transmitted across computer devices as a transaction data message. In one embodiment, when an accountholder performs a transaction at merchant computing device 180 associated with a merchant, transaction data for the transaction is transmitted to server system 112. Server system 112 processes the transaction data in the manner described with respect to FIG. 1 and also provides it to LV computing device 150. LV computing device 150 is also configured to communicate with accountholder computing device 170 via an electronic communication channel or method that is distinct from one used to communicate transaction data. In the example embodiment, LV computing device 150 is configured to communicate with accountholder computing device 170 via electronic communication channel 135.

The transaction data message may also include a transaction amount, a transaction date, account data related to the payment card used to perform the transaction (e.g., primary account number associated with payment card, card expiration date, card issuer, card security code, or the like), a merchant identifier, stock-keeping unit (SKU) data relating to the goods or services purchased from the accountholder, or the like. In one embodiment, the transaction data message also includes location data. As used herein, address data, city data, state data, zip or postal code data, country data, merchant location identifier data, IP address data, MAC address data, or the like. LV computing device 150 is configured to extract location data from transaction data and process it verifying an accountholder's location. In one embodiment, LV computing device 150 parses the complete transaction data file searching for, filtering, or otherwise extracting location data. For example, LV computing device 150 may determine after parsing the complete transaction data file that it contains a city identifier.

Database server 116 is connected to database 120, which contains information on a variety of matters, as described below in greater detail. In one embodiment, database 120 is stored on server system 112 and can be accessed by potential users of server system 112. In an alternative embodiment, database 120 is stored remotely from server system 112 and may be non-centralized. Database 120 may include a single database having separated sections or partitions or may include multiple databases, each being separate from each other. Database 120 may store location data for each accountholder in communication with LV computing device 150.

In the example embodiment, LV computing device 150 includes specifically designed computer hardware to perform the steps described herein, and includes specifically designed computer implementation instructions. LV computing device 150 is a specially designed and customized computer device built to perform the specific function of verifying the location of an accountholder during a transaction by receiving location data from accountholder computing devices, processing those inputs, and generating outputs (e.g., authorization request messages) that are transmitted to other computing devices (e.g., issuer computing devices).

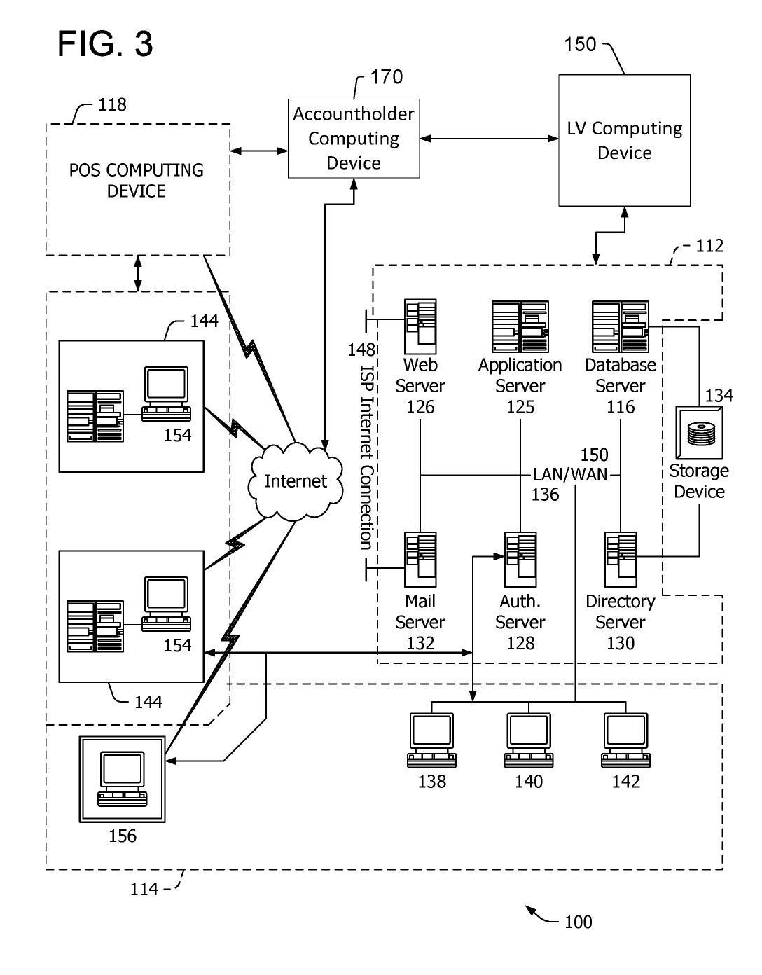

FIG. 3 is an expanded block diagram of an example embodiment of server architecture of location verification (LV) computer system including other computer devices in accordance with one embodiment of the present disclosure. Components in AR computer system 100, identical to components of environment 100 (shown in FIG. 2), are identified in FIG. 3 using the same reference numerals as used in FIG. 2. AR computer system 100 includes server system 112 (similar to LV computing device 150, shown in FIG. 2. Server system 112 further includes database server 116, a web server 126, a user authentication system 106, and an application server 125. A storage device 134 is coupled to database server 116. Servers 116, 124, 126, 128, 130, and 132 are coupled in a local area network (LAN) 136. In addition, an issuer bank workstation 138 (similar to issuer computing device 114 shown in FIG. 2), acquirer bank workstation 140, and a third party processor workstation 142 may be coupled to LAN 136.

In the example embodiment, issuer bank workstation 138, acquirer bank workstation 140, and third party processor workstation 142 are coupled to LAN 136 using network 115. Workstations 138, 140, and 142 are coupled to LAN 136 using an Internet link or are connected through an Intranet. In the example embodiment, LV computing device 150 is in communication with issuer bank workstation 138 and accountholder computer device 124. Accountholder computer device 170 is also connected to the Internet and may be a smartphone, personal computer, tablet computer, or simil LV computing device. LV computing device 150 is configured to receive location data from accountholder computing device 170 via server system 112, process the location data and transmit it to issuer bank workstation 138.

Each workstation 138, 140, and 142 is a computer with Internet access. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees and third parties 144 (e.g., account holders, customers, auditors, developers, accountholders, merchants, acquirers, issuers, etc.), using an ISP Internet connection 148. The communication in the example embodiment is illustrated as being performed using the Internet. However, any other wide area network (WAN) type communication can be utilized in other embodiments. In other words, the systems and processes are not limited to being practiced using the Internet.

In the example embodiment, any authorized individual having a workstation 154 can access AR computer system 100. At least one of the client systems includes a manager workstation 156 located at a remote location. Workstations 154 and 156 are personal computers having a web browser. Also, workstations 154 and 156 are configured to communicate with server system 112. Furthermore, authentication server 128 communicates with remotely located client systems, including a client system 156 using a telephone link. Authentication server 128 is configured to communicate with other client workstations 138, 140, and 142 as well.

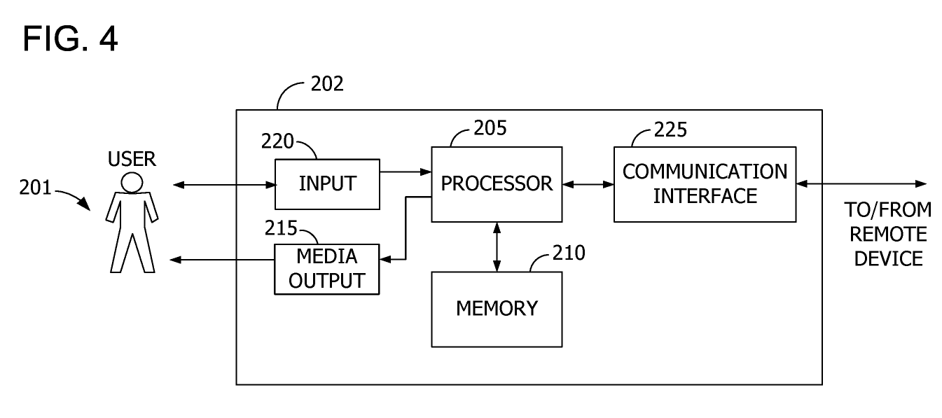

FIG. 4 illustrates an example configuration of a user system, such as an accountholder computer device configured to transmit data to the LV computing device. User system 202 may include, but is not limited to, accountholder computing device 170. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. For example, media output component 215 may be a display component configured to display component lifecycle data in the form of reports, dashboards, communications, or the like. In some embodiments, media output component 215 includes an output adapter such as a video adapter and/or an audio adapter. An output adapter is operatively coupled to processor 205 and operatively connectable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively connectable to a remote device such as Server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a web site from server system 112. A client application allows user 201 to interact with a server application from server system 112.

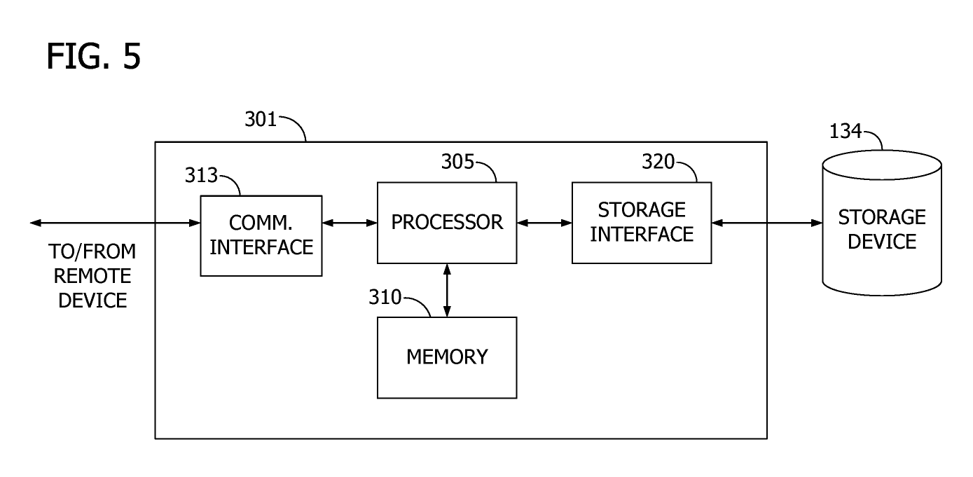

FIG. 5 illustrates an example configuration of a server system 301 such as the server system 112 shown in FIG. 2 that includes LV computing device 150. Server system 301 may include, but is not limited to, database server 116 or LV computing device 150 (shown in FIG. 2). In some embodiments, server system 301 is similar to server system 112 (shown in FIG. 2).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. More specifically, the instructions may cause various data manipulations on data stored in storage 134 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive communications from issuer computing devices 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. In other embodiments, storage device 134 is external to server system 301 and is similar to database 120 (shown in FIG. 2). For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

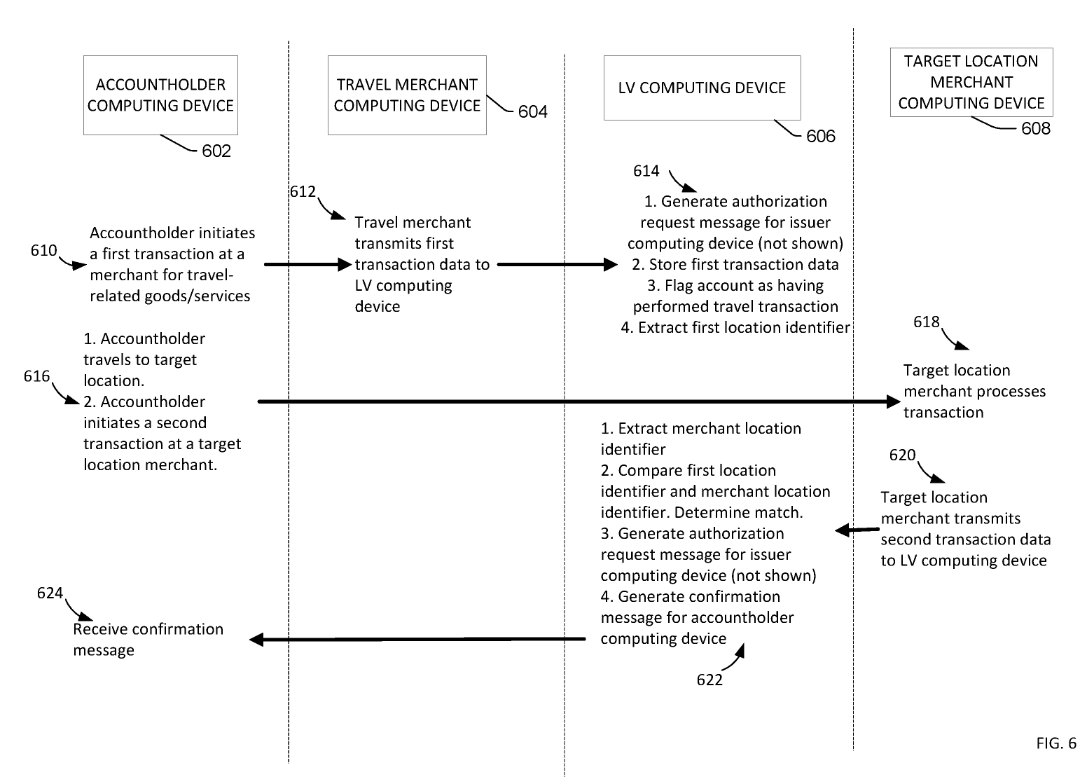

FIG. 6 shows an example message flow by which the LV computing device (shown in FIG. 2) verifies the location of an accountholder. As shown in FIG. 6, an accountholder initiates 610 a transaction (also referred to herein as a travel transaction) using accountholder computing device 602. In one embodiment, the travel transaction is for travel-related goods or services and initiated with travel merchant computing device 604, associated with a travel merchant. For example, the travel transaction may be an airline ticket purchase from an airline website in order to travel to a target location. Travel merchant computing device 604 processes the travel transaction and transmits first transaction data to LV computing device 606 (similar to LV computing device 150, shown in FIG. 2). First transaction data includes data relating to transaction time, transaction date, transaction amount, and the like. In the exemplary embodiment, first transaction data also includes data relating to the accountholder's domicile location (i.e., location of residence) and the target location. For example, first transaction data may include the departure and destination city or country for the airline ticket that the accountholder purchased. Alternatively, or in addition to the destination city or country, first transaction data may also include a transaction code, merchant code, classification code, or a similar identifier identifying the transaction as relating to travel.

In one embodiment, first transaction data is transmitted via a transaction message route used for transaction processing. In another embodiment, LV computing device 606 is configured to receive first transaction data through a separate and distinct electronic network route that LV computing device 606 uses to receive and process location information in order to perform the systems and methods described herein.

LV computing device 606 is configured to store 614 the first transaction data that is received, and generate an authorization request message for an issuer computing device (not shown) that is associated with an issuer bank that issued the account used by the accountholder. The authorization request message is generated and transmitted in order to continue processing the travel transaction. LV computing device 606 is also configured to flag the account as having performed a travel transaction. In one embodiment, LV computing device 606 is configured to copy records for such accounts into a separate transaction database for quick retrieval in the future. In a related embodiment, LV computing device 606 adds a travel flag to its account records for such accounts, indicating that the account was used for a travel transaction. LV computing device 606 is also configured to extract a first location identifier from first transaction data. In one embodiment, the first location identifier represents a domicile location for the accountholder. In one embodiment, the first location identifier represents the city, state, postal code, or country of residence for the accountholder. In another embodiment first location identifier represents a complete address associated with the accountholder (e.g., the address associated with the account used to perform the travel transaction). In yet another embodiment, the first location identifier represents the departure location for the airline ticket purchased by the accountholder, indicating that the departure location is also the accountholder's location of residence or domicile.

At some point after the accountholder has initiated the travel transaction, the accountholder will travel to the target location. In the exemplary embodiment, the accountholder will initiate 616 a second transaction (also referred to herein as a target location transaction) at the target location. The target location transaction is performed using target location merchant computing device 608 at the target location. For example, after flying to the target location (such as another country), the accountholder may visit a coffee shop at the target location and use the accountholder's account to purchase coffee. Target location merchant computing device 608 processes 618 the target location transaction, which generates second transaction data. For example, second transaction data includes a transaction date, a transaction time, a transaction amount, merchant identifiers, and the like. In one embodiment, second transaction data includes a merchant location identifier for the coffee shop that is operating target location merchant computing device 608. The merchant location identifier may be a city, state, country, or postal code identifier. The merchant location identifier may also be an Internet Protocol (IP) address or media access control (MAC) address for target location merchant computing device 608.

In another embodiment, LV computing device 606 is configured to use the accountholder's transaction history within a geographical location and isolate the likely position of the accountholder's domicile. For example, LV computing device 606 may be programmed with a location rule that an accountholder's domicile is likely to be near where the accountholder performs the largest number of transactions. Accordingly, LV computing device 606 is configured to tabulate transaction history by sorting on transaction frequency per merchant. Using a defined number of the top most frequently visited merchants, LV computing device 606 is configured to triangulate the likely domicile of the accountholder. In a related embodiment, LV computing device 606 is configured to determine, based on an originating IP address or geo-location for the accountholder's online transactions, that accountholder computing device 602 is located at a domicile location for the accountholder. LV computing device 606 is also configured to use a combination of methods described in the various embodiments above in order to determine domicile location for the accountholder.

Similarly, to determine the target location, LV computing device 606 is configured to perform the actions described in the abovementioned embodiments. Additionally, the currency identifier used in the transaction can be used to determine the likely country or city in which the target location transaction was initiated. Furthermore, LV computing device 606 is configured to receive accountholder profile data from target merchant location computing device 608, where available, in order to determine the accountholder's domicile location, spending patterns, travel information, and the like. Relatedly, LV computing device 606 is configured to bind or otherwise associate the data received from target merchant location computing device 608 to the accountholder's account identifiers, electronic wallet identifiers, and the like.

Target location merchant computing device 608 transmits 620 the second transaction data to LV computing device 606. In one embodiment, second transaction data is transmitted via a transaction message route used for transaction processing. In another embodiment, LV computing device 606 is configured to receive second transaction data through a separate and distinct electronic network route that LV computing device 606 uses to receive and process location information in order to perform the systems and methods described herein.

LV computing device 606 is configured to extract the merchant location identifier 622 from second transaction data. LV computing device 606 is configured to compare the first location identifier received from the initial travel transaction and the merchant location identifier now received from the current travel transaction. In one embodiment, LV computing device 606 compares the destination city or country from the airline purchase in the travel transaction to the city or country associated with target location merchant computing device 608 as received from within second transaction data. In another embodiment, LV computing device 606 is configured to translate a destination city identifier into a series or range of IP or MAC addresses and compare the series to the IP address of target location merchant computing device 608. Conversely, LV computing device 606 is configured to translate an IP or MAC address into a city identifier and compare the resulting city identifier to the city identifier received for target location merchant computing device 608.

If there is a match, LV computing device 606 is configured to generate an authorization request message for issuer computing device (not shown). Additionally, LV computing device 606 is configured to generate an accountholder confirmation message for accountholder computing device 602 in order to confirm that the target location transaction was approved. In one embodiment, LV computing device 606 the accountholder confirmation message requests a final confirmation from the accountholder before authorizing the transaction. For example, LV computing device 606 first determines that the merchant location identifier matches the target location provided from first transaction data, then sends an accountholder confirmation request message to accountholder computing device 602. If the accountholder provides a confirmation, LV computing device 606 processes the transaction or authorizes it for processing. In another embodiment, LV computing device 606 simply authorizes the transaction without requesting confirmation.

In another embodiment, LV computing device 606 is configured to determine a radius around a destination city identifier received from first transaction data, and determine locations within that radius in which an accountholder can reasonably have been expected to perform the target location transaction. For example, the airline ticket purchase described above may state a departure city of Chicago, USA, and a destination city of London, UK. However, the target location transaction may be performed at Cambridge, UK, a city that is approximately 60 miles from London. In this example, the accountholder may have flown to London, driven to Cambridge, then purchased the coffee in Cambridge. Accordingly, LV computing device 606 is configured to determine whether Cambridge falls within an acceptable radius within which a legitimate accountholder may have traveled around the destination city. If so, LV computing device 606 considers the target location transaction (at Cambridge) to be legitimate and prepares the transaction for further processing.

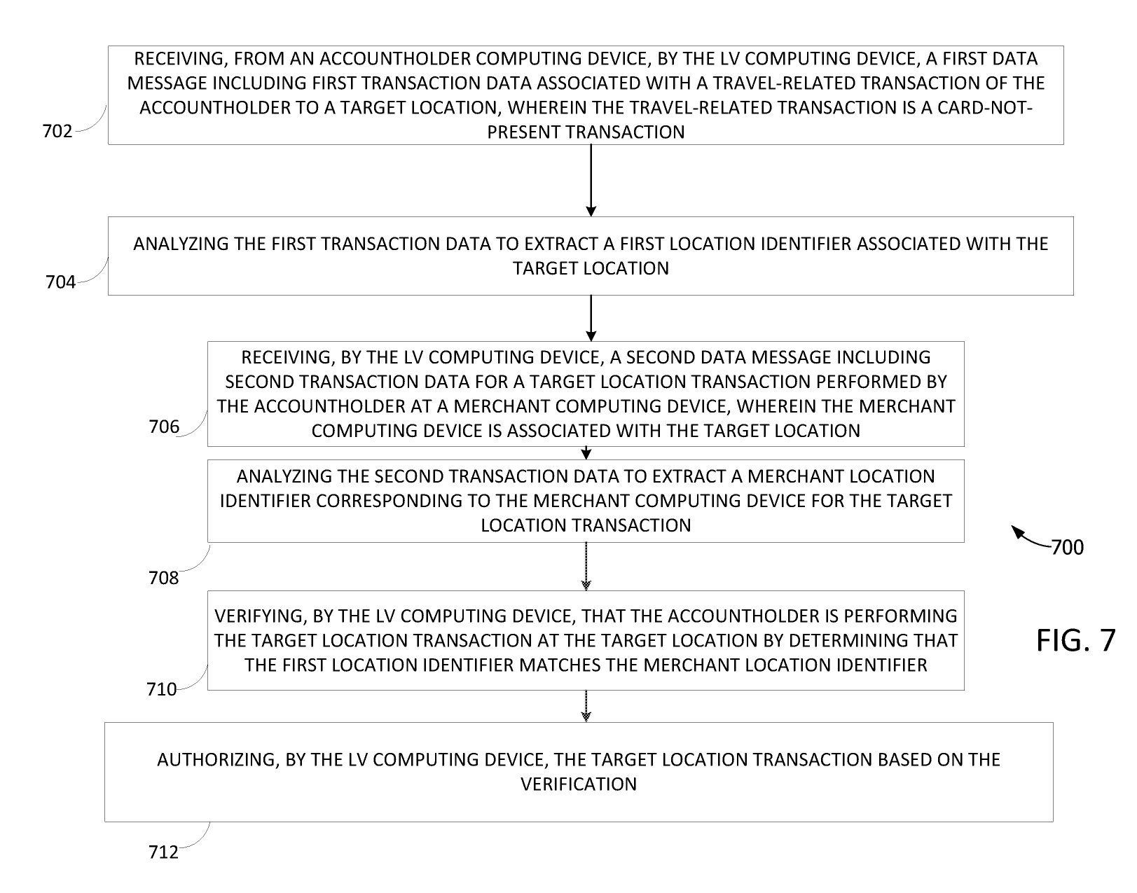

FIG. 7 is an example flow diagram illustrating a method flow by which the LV computing device verifies the location of an accountholder. In the example embodiment, LV computing device 606 receives 702, from an accountholder computing device, a first data message including first transaction data associated with a travel-related transaction of the accountholder to a target location. In one embodiment, the travel-related transaction is a card-not-present transaction (i.e., the accountholder does not present a physical payment card to a merchant). For example, the travel-related transaction may be performed online through a website. LV computing device 606 analyzes 704 the first transaction data to extract a first location identifier associated with the target location.

In one embodiment, at some point after the travel-related transaction, the accountholder travels to the target location. At the target location, the accountholder performs another transaction (referred to herein as a target location transaction). LV computing device 606 receives 706 a second data message including second transaction data for the target location transaction performed by the accountholder at a merchant computing device. LV computing device 606 analyzes 708 the second transaction data to extract a merchant location identifier corresponding to the merchant computing device for the target location transaction. LV computing device 606 verifies 710 that the accountholder is performing the target location transaction at the target location by determining that the first location identifier matches the merchant location identifier. LV computing device 606 authorizes 712 the target location transaction based on the verification.

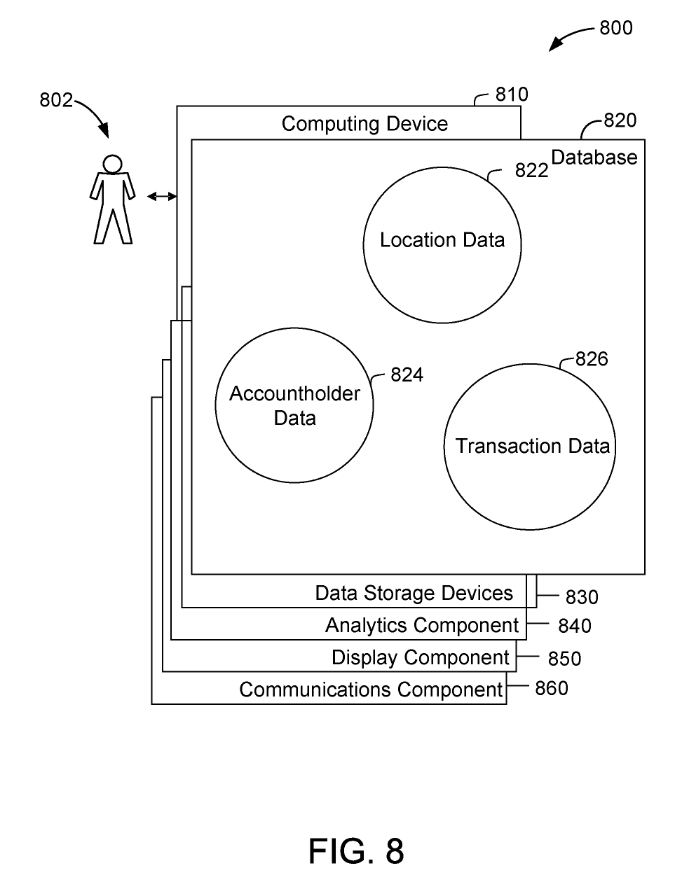

FIG. 8 shows an example configuration of a database 800 within a computing device, along with other related computing components, that may be used to verify the location of an accountholder. In some embodiments, computing device 810 is similar to server system 112 (shown in FIG. 2). User 802 (such as a user operating server system 112) may access computing device 810 in order to verify an accountholder's location. In some embodiments, database 820 is similar to database 120 (shown in FIG. 2). In the example embodiment, database 820 includes location data 822, accountholder data 824, and transaction data 826. Location data 822 includes address data, city data, state data, zip or postal code data, country data, merchant location identifier data, IP address data, MAC address data, or the like.

Accountholder data 824 includes accountholder personal data (e.g., address, telephone number, account numbers), issuer data, or the like. Transaction data 826 includes transaction amounts, transaction dates/times, account data related to the payment card used to perform the transaction (e.g., primary account number associated with payment card, card expiration date, card issuer, card security code, or the like), merchant identifiers, stock-keeping unit (SKU) data relating to the goods or services purchased from the accountholder, or the like.

Computing device 810 also includes data storage devices 830. Computing device 810 also includes analytics component 840 that processes location verification requests. Computing device 810 also includes display component 850 that receives processed location verification data from analytics component 840 and converts it into various formats in order to provide location data in a format compatible with various different user computing devices. Computing device 810 also includes communications component 860 which is used to communicate with accountholder computing devices, issuer computing devices, and merchant computing devices, using predefined network protocols such as TCP/IP (Transmission Control Protocol/Internet Protocol) over the Internet.

As will be appreciated based on the foregoing specification, the above-described embodiments of the disclosure may be implemented using computer programming or engineering techniques including computer software, firmware, hardware or any combination or subset thereof, wherein the technical effect is to verify the location of an accountholder. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of verifying a location of an accountholder, the method implemented using a location verification (LV) computing device, the method comprising:
receiving, from an accountholder computing device, by the LV computing device, a first data message including first transaction data associated with a travel-related transaction of the accountholder to a target location, wherein the travel-related transaction is a card-not-present transaction;
analyzing the first transaction data to extract a first location identifier associated with the target location;
receiving, by the LV computing device, a second data message including second transaction data for a target location transaction performed by the accountholder at a merchant computing device, wherein the merchant computing device is associated with the target location;
analyzing the second transaction data to extract a merchant location identifier corresponding to the merchant computing device for the target location transaction;
verifying, by the LV computing device, that the accountholder is performing the target location transaction at the target location by determining that the first location identifier matches the merchant location identifier; and
authorizing, by the LV computing device, the target location transaction based on the verification.

2. A method in accordance with claim 1, wherein the first transaction data includes a card presence identifier, and wherein the card presence identifier indicates an electronic transaction performed without use of a physical payment card and using the accountholder computing device at a domicile location of the accountholder.

3. A method in accordance with claim 1, wherein the second transaction data includes the card presence identifier, and wherein the card presence identifier indicates at least one of an electronic transaction and a card-present transaction.

4. A method in accordance with claim 1, wherein the target location is distinct from the domicile location.

5. A method in accordance with claim 1, further comprising:
calculating a score representing a fraud risk by processing the first transaction data and the second transaction data with one or more fraud risk scoring models.

6. A method in accordance with claim 1, further comprising:
receiving a third data message from a social network computing device, wherein the third data message includes a target location identifier;
comparing the target location identifier to the merchant location identifier; and
authorizing the target location transaction performed by the accountholder at the target location based on the comparing.

7. A method in accordance with claim 1, further comprising:
declining the target location transaction based on a determination that the first location identifier does not match the merchant location identifier.

8. A system for verifying a location of an accountholder, the system comprising:
a memory device configured to store location data; and
a location verification (LV) computing device in communication with a memory device, the LV computing device further configured to:
receive, from an accountholder computing device, a first data message including first transaction data associated with a travel-related transaction of the accountholder to a target location, wherein the travel-related transaction is a card-not-present transaction;
analyze the first transaction data to extract a first location identifier associated with the target location;
receive a second data message including second transaction data for a target location transaction performed by the accountholder at a merchant computing device, wherein the merchant computing device is associated with the target location;
analyze the second transaction data to extract a merchant location identifier corresponding to the merchant computing device for the target location transaction;
verify that the accountholder is performing the target location transaction at the target location by determining that the first location identifier matches the merchant location identifier; and
authorize the target location transaction based on the verification.

9. A system in accordance with claim 8, wherein the first transaction data includes a card presence identifier, and wherein the card presence identifier indicates an electronic transaction performed without use of a physical payment card and using the accountholder computing device at a domicile location of the accountholder.

10. A system in accordance with claim 8, wherein the second transaction data includes the card presence identifier, and wherein the card presence identifier indicates at least one of an electronic transaction and a card-present transaction.

11. A system in accordance with claim 8, wherein the target location is distinct from the domicile location.

12. A system in accordance with claim 8, wherein the LV computing device is further configured to:
calculate a score representing a fraud risk by processing the first transaction data and the second transaction data with one or more fraud risk scoring models.

13. A system in accordance with claim 8, wherein the LV computing device is further configured to:
receive a third data message from a social network computing device, wherein the third data message includes a target location identifier;
compare the target location identifier to the merchant location identifier; and
authorize the target location transaction performed by the accountholder at the target location based on the comparing.

14. A system in accordance with claim 8, wherein the LV computing device is further configured to:
decline the target location transaction based on a determination that the first location identifier does not match the merchant location identifier.

15. A non-transitory computer readable medium that includes computer executable instructions for verifying a location of an accountholder for a payment transaction conducted by the accountholder with a merchant, wherein when executed by a location verification (LV) computing device comprising a processor in communication with a memory device, the computer executable instructions cause the LV computing device to:
receive, from an accountholder computing device, a first data message including first transaction data associated with a travel-related transaction of the accountholder to a target location, wherein the travel-related transaction is a card-not-present transaction;
analyze the first transaction data to extract a first location identifier associated with the target location;
receive a second data message including second transaction data for a target location transaction performed by the accountholder at a merchant computing device, wherein the merchant computing device is associated with the target location;
analyze the second transaction data to extract a merchant location identifier corresponding to the merchant computing device for the target location transaction;
verify that the accountholder is performing the target location transaction at the target location by determining that the first location identifier matches the merchant location identifier; and
authorize the target location transaction based on the verification.

16. A non-transitory computer readable medium in accordance with claim 15, wherein the first transaction data includes a card presence identifier, and wherein the card presence identifier indicates an electronic transaction performed without use of a physical payment card and using the accountholder computing device at a domicile location of the accountholder.

17. A non-transitory computer readable medium in accordance with claim 15, wherein the second transaction data includes the card presence identifier, and wherein the card presence identifier indicates at least one of an electronic transaction and a card-present transaction.

18. A non-transitory computer readable medium in accordance with claim 15, wherein the second transaction data includes the card presence identifier, and wherein the card presence identifier indicates at least one of an electronic transaction and a card-present transaction.

19. A non-transitory computer readable medium in accordance with claim 15, wherein the computer-executable instructions cause the LV computing device to:
calculate a score representing a fraud risk by processing the first transaction data and the second transaction data with one or more fraud risk scoring models.

20. A non-transitory computer readable medium in accordance with claim 15, wherein the computer-executable instructions cause the LV computing device to:
receive a third data message from a social network computing device, wherein the third data message includes a target location identifier;
compare the target location identifier to the merchant location identifier; and
authorize the target location transaction performed by the accountholder at the target location based on the comparing.
